(19) United States
(12) Patent Application Publication
(10) Pub. No.: US 2020/0148083 A1
(43) Pub. Date: May 14, 2020

(54) FINISHER FOR HEADREST AND VEHICLE SEAT

(71) Applicant: TACHI-S ENGINEERING U.S.A., INCORPORATED, Farmington Hills, MI (US)

(72) Inventors: Yasuo KAKISHIMA, Farmington Hills, MI (US); Ravi KRISHNAN, Farmington Hills, MI (US)

(21) Appl. No.: 16/190,361

(22) Filed: Nov. 14, 2018

(51) Int. Cl. B60N 2/812

(52) U.S. Cl. CPC B60N 2/812; B60N 2002/899

(57) ABSTRACT

To provide a technique that allows comparatively easy mounting of a cover (finisher) that covers a bottom surface of a headrest body. A headrest includes a headrest body, a headrest pillar, and a finisher. The headrest pillar projects from a bottom surface of the headrest body. The finisher has an opening portion into which the headrest pillar is inserted. The headrest pillar extends to an inside of the headrest body. The finisher is fixed to the headrest pillar at the inside of the headrest body. The finisher covers the bottom surface of the headrest body.

### BACKGROUND

The present invention is applicable to a finisher for a headrest and a vehicle seat including the headrest.

Generally, a headrest to protect a head of an occupant is mounted to an upper portion of a seat back of a vehicle seat. There has been proposed a technique as this type of headrest that includes an outer cover molded with synthetic resin at a bottom surface of the headrest and the outer cover is fixed to an inner cover of the headrest (see JP-A-2000-38072).

There is a demand to further simply mount a cover (finisher) that covers a bottom surface of a headrest body.

### SUMMARY OF THE INVENTION

An object of the present invention is to provide a technique that allows comparatively easily mounting a cover (finisher) that covers a bottom surface of a headrest body.

Other objects and novel features will become clear by descriptions in this Description and attached drawings.

A brief description of an outline of representative configurations of the present invention is as follows.

That is, a headrest includes a headrest body, a headrest pillar, and a finisher. The headrest pillar projects from a bottom surface of the headrest body. The finisher has an opening portion into which the headrest pillar is inserted. The headrest pillar extends to an inside of the headrest body. The finisher is fixed to the headrest pillar at the inside of the headrest body. The finisher covers the bottom surface of the headrest body.

The vehicle seat allows comparatively easily mounting a cover (finisher) that covers a bottom surface of a headrest body.

### BRIEF DESCRIPTION OF THE DRAWINGS

FIG. 1 is a front perspective view of a vehicle seat according to a first embodiment;

FIG. 2 is a perspective view when a headrest body is viewed from a lower side;

FIG. 3 is a conceptual transparent cross-sectional view when a headrest is viewed from a right side surface;

FIG. 4 is a perspective view illustrating a headrest frame;

FIG. 5A is a plan view illustrating a back surface of a finisher;

FIG. 5B is a conceptual cross-sectional view when the finisher is viewed from a lateral side;

FIG. 6 is a cross-sectional view to describe a method for mounting the finisher to the bottom surface of the headrest body;

FIG. 7A is a cross-sectional view illustrating a state of mounting the finisher to the bottom surface of the headrest body;

FIG. 7B illustrates an enlarged cross-sectional view of a notch;

FIG. 8 is a perspective view illustrating a first modification of a finisher;

FIG. 9A is a rear perspective view illustrating a state of raising the headrest body upward a little;

FIG. 9B is a rear perspective view illustrating a state of lowering the headrest body;

FIG. 10 is a perspective view of a back surface of the finisher according to a second embodiment;

FIG. 11 is a rear cross-sectional view illustrating the headrest body, the finisher, and an upper portion of the seat back;

FIG. 12A is a modification of a configuration of mounting the finisher to the bottom surface of the headrest body and is a drawing illustrating a J-shaped hook; and

FIG. 12B is a modification of the configuration of mounting the finisher to the bottom surface of the headrest body and is a drawing illustrating a clamp.

### DETAILED DESCRIPTION OF THE PREFERRED EMBODIMENTS

The following describes embodiments of the present invention with reference to the drawings.

Note the disclosure is merely one example, and, for clearer descriptions, the drawings are schematically illustrated in width, thickness, shape, and similar factor of each unit compared with those of actual aspects in some cases. However, they are not intended to limit interpretations of the present invention. In the present description and the respective drawings, components similar to those described previously with reference to earlier figures are labeled with like reference numerals, and the detailed description thereof is omitted appropriately. In the following description, unless otherwise stated, the front, rear, upper, lower, left, and right are intended to mean the front, rear, upper, lower, left, and right of a vehicle.

### First Embodiment

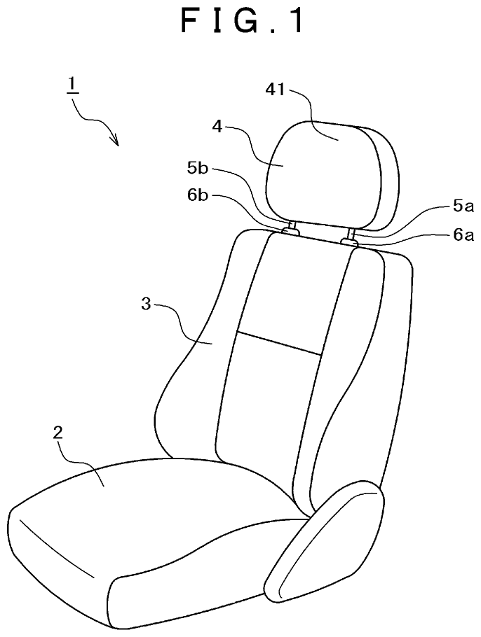

FIG. 1 is a front perspective view of a vehicle seat according to the first embodiment.

A vehicle seat 1 includes a seat cushion 2, a seat back 3 coupled to the seat cushion 2 via a reclining mechanism, and a headrest 4 disposed at the upper portion of the seat back 3. The headrest 4 includes a headrest body 41, a pair of headrest pillars 5a and 5b projecting from the bottom surface of the headrest body 41. The pair of headrest pillars 5a and 5b is inserted into a pair of headrest guides 6a and 6b, which is disposed at the upper portion of the seat back 3, to be fixed. The headrest pillars 5a and 5b are insertable into/removable from the headrest guides 6a and 6b at the top of the seat back 3, and an amount of insertion is adjustable with respect to the seat back 3 such that the position of the headrest 4 matches a position of a head of an occupant.

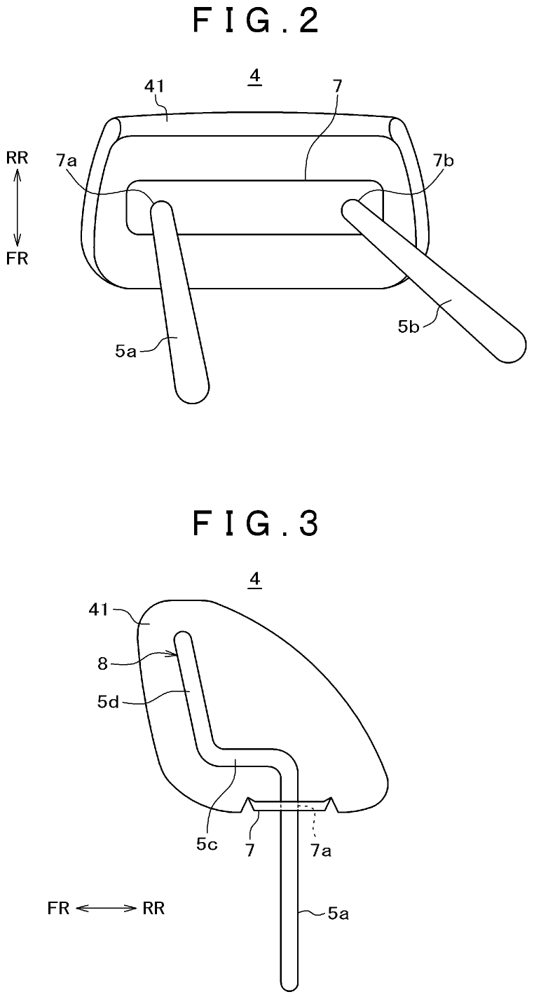

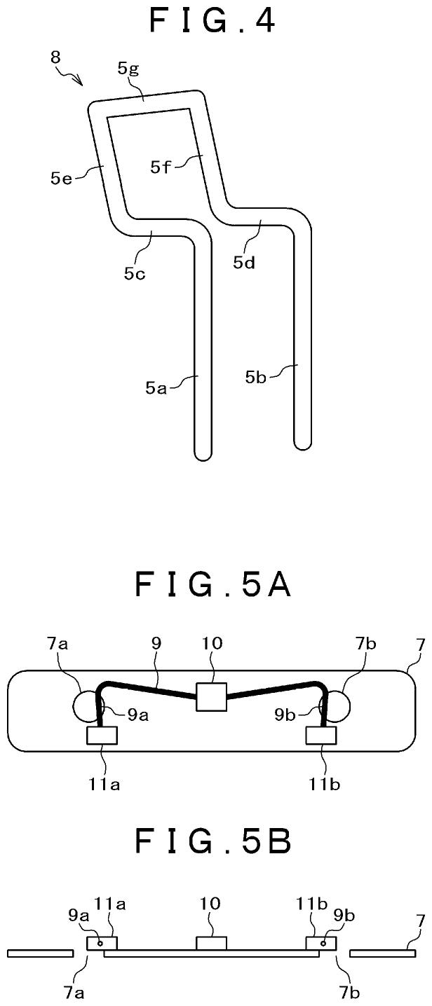

FIG. 2 is a perspective view when the bottom surface of the headrest body 41 is viewed from a lower side. In FIG. 2, the upper side is a rear side (RR) of the headrest 4 and the lower side is a front side (FR) of the headrest 4. FIG. 3 is a conceptual transparent cross-sectional view when the headrest 4 is viewed from a right side surface. FIG. 4 is a perspective view illustrating a headrest frame.

As illustrated in FIG. 2 and FIG. 3, a finisher 7 is disposed at the bottom surface of the headrest body 41. The finisher 7 can also be referred to as a cover member. The finisher 7 is formed of a plate member made of resin as one example. The finisher 7 has a pair of circular opening portions 7a and 7b through which the headrest pillars 5a and 5b, which have a cross-sectional circular shape, pass. The opening portions 7a and 7b have a diameter approximately identical value to a diameter of the headrest pillars 5a and 5b. The finisher 7 is fixed to the headrest pillars 5a and 5b as described later.

The finisher 7 has a role to improve a quality of external appearance when the bottom surface of the headrest body 41 is viewed from the lower side. That is, although FIG. 3 omits the illustration, the headrest body 41 generally includes a cushion material and a skin disposed so as to cover the cushion material. The skin to cover the cushion material is gathered for eliminating slack. This part (end processed unit) where the skin is gathered is positioned on the back surface side of the finisher 7. That is, since covered with the finisher 7, the end processed unit is never seen.

Accordingly, when the bottom surface of the headrest body 41 is viewed from the lower side, since the end processed unit where the skin is gathered is covered with the finisher 7, the quality of external appearance of the bottom surface of the headrest body 41 can be improved.

As illustrated in FIG. 3 and FIG. 4, a headrest frame 8 includes the headrest pillars 5a and 5b, which extend downward, horizontal portions 5c and 5d, which are coupled to the upper portions of the headrest pillars 5a and 5b and extend approximately horizontally in a front-rear direction, inclined portions 5e and 5f, which are coupled to the horizontal portions 5c and 5d, and a coupling portion 5g, which couples between the upper portions of the inclined portions 5e and 5f.

FIG. 5A and FIG. 5B are drawings describing the configuration of the finisher 7, FIG. 5A is a plan view illustrating the back surface of the finisher 7, and FIG. 5B is a conceptual cross-sectional view when the finisher 7 is viewed from the lateral side.

As illustrated in FIG. 5A, the finisher 7 has the pair of opening portions 7a and 7b. A spring member 9 is disposed on the back surface of the finisher 7. The spring member 9 is fixed to a first fixing portion 10, which is disposed on the back surface of the finisher 7, at the center part. One distal end part of the spring member 9 is fixed with a second fixing portion 11a, which is disposed on the back surface of the finisher 7. The other distal end part of the spring member 9 is fixed with a second fixing portion 11b, which is disposed on the back surface of the finisher 7.

As illustrated in FIG. 5A and FIG. 5B, the spring member 9 is disposed so as to go across the outer circumferences of the pair of opening portions 7a and 7b. That is, parts 9a and 9b of the spring member 9 are disposed so as to go across the arcs of the circular opening portions 7a and 7b. Accordingly, in plan view, the parts 9a and 9b of the spring member 9 are positioned on the openings of the opening portions 7a and 7b.

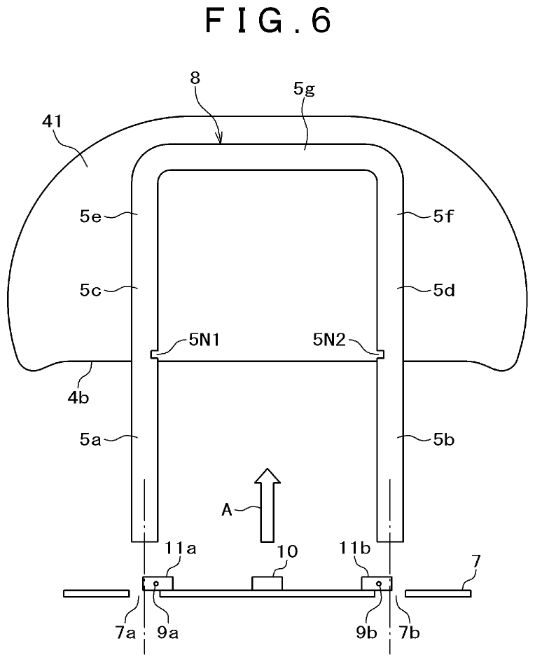

FIG. 6 is a cross-sectional view to describe a method for mounting the finisher 7 to the bottom surface of the headrest body 41.

The headrest pillars 5a and 5b have a pair of notches 5N1 and 5N2 on the upper side of a part corresponding to a bottom surface 4b of the headrest body 41. The notches 5N1 and 5N2 can also be referred to as depressed portions, recessed portions, and cutout portions. The notches 5N1 and 5N2 are disposed such that the parts 9a and 9b, which are positioned above the openings of the opening portions 7a and 7b, of the spring member 9 enter into the notches 5N1 and 5N2.

When the finisher 7 is mounted to the bottom surface of the headrest body 41, as indicated by the arrow A in FIG. 6, the headrest pillars 5a and 5b are inserted into the opening portions 7a and 7b of the finisher 7.

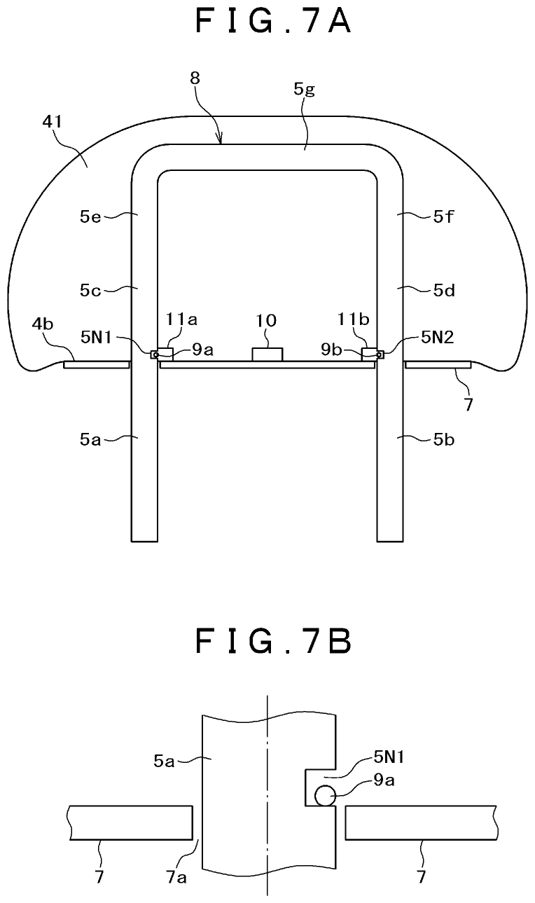

FIG. 7A and FIG. 7B are cross-sectional views to describe the state of mounting the finisher 7 to the bottom surface of the headrest body 41. FIG. 7A is a cross-sectional view illustrating the state of mounting the finisher 7 to the bottom surface 4b of the headrest body 41. FIG. 7B illustrates an enlarged cross-sectional view of the notch 5N1.

As illustrated in FIG. 7A, the back surface of the finisher 7 is pressed so as to be in contact with the bottom surface 4b of the headrest body 41 to mount the finisher 7 to the bottom surface 4b of the headrest body 41. At this time, as illustrated in FIG. 7B, the part 9a of the spring member 9 enters into the notch 5N1. Similarly, the part 9b of the spring member 9 enters into the notch 5N2. Thus, by fixing the finisher 7 to the notches 5N1 and 5N2 of the headrest pillars 5a and 5b, the finisher 7 is fixed to the bottom surface 4b of the headrest body 41.

Note that FIG. 6, FIG. 7A, and FIG. 7B illustrate the configuration example where the notches 5N1 and 5N2 are disposed at the parts opposed to the headrest pillars 5a and 5b ; however, the configuration is not limited to this. The notches 5N1 and 5N2 only need to be disposed at parts positioned on the upper side of the bottom surface 4b of the headrest body 41 at the headrest pillars 5a and 5b. In this case, the positions of the parts 9a and 9b of the spring member 9 also only need to be changed at the notches 5N1 and 5N2, which are disposed at the headrest pillars 5a and 5b, considering the positions.

### First Modification of Finisher

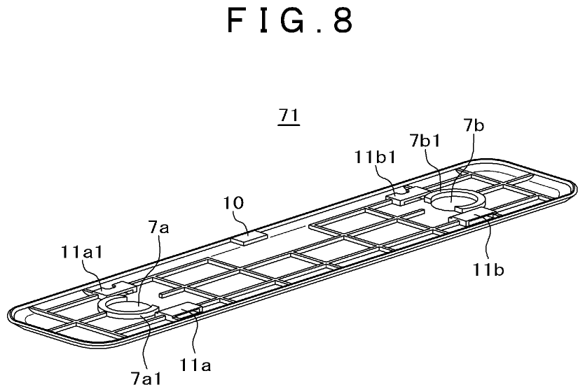

FIG. 8 is a perspective view illustrating the first modification of a finisher. The finisher 7 illustrated in FIG. 5A and FIG. 5B includes the three fixing portions (10, 11a, 11b) to fix the spring member 9. A finisher 71 of FIG. 8 further includes a fourth fixing portion 11a1 and a fifth fixing portion 11b1 as parts to fix the spring member, in addition to the first fixing portion 10, the second fixing portion 11a, and the second fixing portion 11b. A sidewall 7a1 is disposed at the peripheral area of the opening portion 7a, and a sidewall 7b1 is disposed at the peripheral area of the opening portion 7b. A sidewall of the sidewall 7a1 is not disposed at a part of the opening portion 7a where the part 9a of the spring member 9 is disposed to ensure fixing the part 9a of the spring member 9. Similarly, a sidewall of the sidewall 7b1 is not disposed at a part of the opening portion 7b where the part 9b of the spring member 9 is disposed to ensure fixing the part 9b of the spring member 9.

Thus, the configuration of the finisher 71 of the first modification also allows fixing the finisher 71 to the bottom surface 4b of the headrest body 41 similarly to the finisher 7 of the first embodiment.

### Second Modification of Finisher

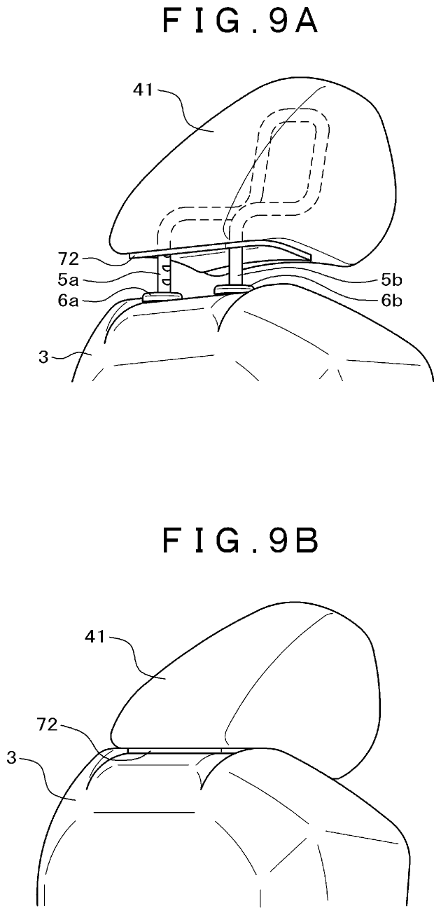

FIG. 9A and FIG. 9B are rear perspective views illustrating the headrest body 41 and the upper portion of the seat back 3. FIG. 9A is a rear perspective view illustrating a state of raising the headrest body 41 upward a little. FIG. 9B is a rear perspective view illustrating a state of lowering the headrest body 41.

The configurations of the finishers 7 and 71 having the flat plate shape have been described above. As illustrated in FIG. 9A, a finisher 72 of the second modification has an upwardly curving shape. As illustrated in FIG. 9B, the configuration of this finisher 72 acts so as to hide the headrest guides 6a and 6b with the headrest body 41 lowered.

With the configuration of the finisher 72 of this second modification, the headrest guides 6a and 6b can be hidden with the headrest body 41 lowered; therefore, the headrest body 41 and the seat back 3 when viewed from the rear becomes an integral shape. This ensures improving the quality of integral external appearance of the headrest body 41 with the seat back 3.

According to the first embodiment, the following effects can be obtained.

1) By fixing the finisher 7, 71, or 72 to the headrest pillars 5a and 5b, the finisher 7, 71, or 72 can be comparatively simply fixed to the bottom surface of the headrest body 41.

2) In 1), the notches 5N1 and 5N2 are disposed at the headrest pillars 5a and 5b, and the parts 9a and 9b, which are disposed at the opening portions 7a and 7b of the finisher 7, of the spring member 9 are inserted into the notches 5N1 and 5N2. This allows comparatively simply and easily fixing the finisher 7, 71, or 72 to the bottom surface of the headrest 4.

2) At the bottom surface of the headrest body 41, the gathered part (end processed unit) of the skin of the headrest body 41 is positioned on the back surface side of the finisher 7, 71, or 72. This ensures improving the quality of external appearance of the bottom surface of the headrest body 41.

3) The headrest body 41 and the seat back 3 when viewed from the rear become the integral shape. Accordingly, the headrest body 41 and the seat back 3 can improve the quality of integral external appearance. Especially, the finisher 72 of the second modification has the upwardly curving shape, and this allows covering the headrest guides 6a and 6b with the headrest body 41 lowered. Therefore, the headrest body 41 and the seat back 3 can further improve the quality of integral external appearance.

### Second Embodiment

The configuration of the finisher 7, 71, or 72 of the first embodiment having the flat plate shape or the upwardly curving plate shape has been described. A finisher 73 of the second embodiment has a configuration that includes recessed portions 731 and 732 configured to house the headrest guides 6a and 6b.

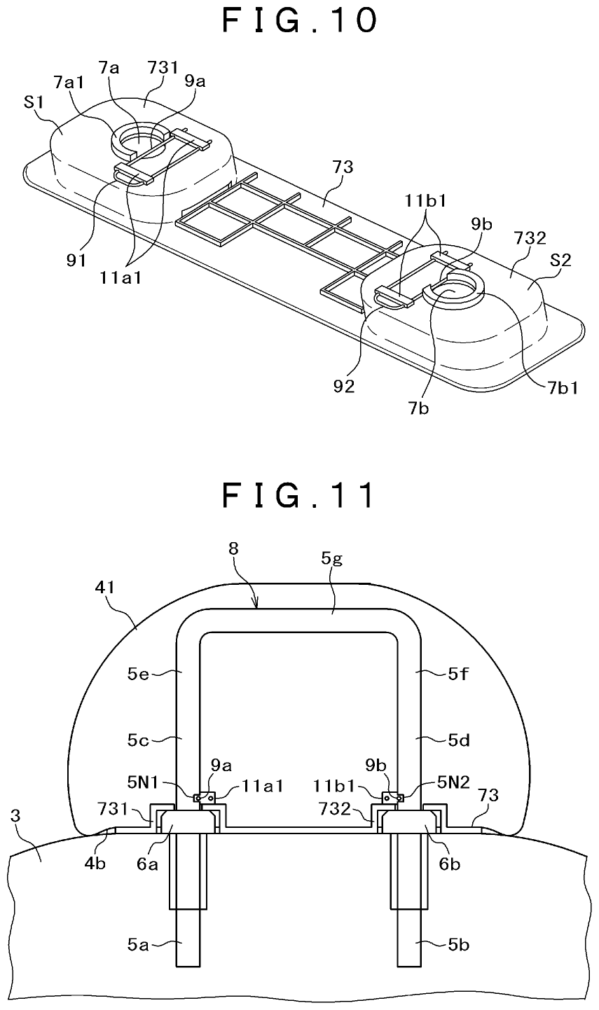

FIG. 10 is a perspective view of the back surface of the finisher 73 according to the second embodiment. FIG. 11 is a rear cross-sectional view illustrating the headrest body 41, the finisher 73, and the upper portion of the seat back 3. FIG. 11 illustrates a state where the headrest body 41 to which the finisher 73 is mounted is lowered and illustrates a state where the headrest guides 6a and 6b are housed in the recessed portions 731 and 732 of the finisher 73.

As illustrated in FIG. 10, the finisher 73 has the recessed portions 731 and 732 opening downward. The recessed portions 731 and 732 are recessed to the extent of being able to house the headrest guides 6a and 6b. The recessed portions 731 and 732 have surfaces S1 and S2 opposed to the headrest body 41.

The recessed portions 731 and 732 have surfaces opposed to the headrest body 41 at the back surface of the finisher 73. The opening portion 7a into which the headrest pillar 5a is inserted is disposed on the surface S1 of the recessed portion 731. The sidewall 7a 1 is disposed at the peripheral area of the opening portion 7a. The pair of fixing portions 11a1 to fix a U-shaped spring member 91 is disposed on the surface S1 of the recessed portion 731. The part 9a of the spring member 91 is disposed so as to go across the arc of the opening portion 7a. A sidewall of the sidewall 7a 1 is not disposed at a part of the opening portion 7a where the part 9a of the spring member 91 is disposed to ensure fixing the part 9a of the spring member 91.

The opening portion 7b into which the headrest pillar 5b is inserted is disposed on the surface S2 of the recessed portion 732. The sidewall 7b1 is disposed at the peripheral area of the opening portion 7b. The pair of fixing portions 11b1 to fix a U-shaped spring member 92 is disposed on the surface S2 of the recessed portion 732. The part 9b of the spring member 92 is disposed so as to go across the arc of the opening portion 7b. A sidewall of the sidewall 7b1 is not disposed at a part of the opening portion 7b where the part 9b of the spring member 92 is disposed to ensure fixing the part 9b of the spring member 92.

As described in FIG. 6, FIG. 7A, and FIG. 7B, the finisher 73 is mounted to the headrest body 41 by inserting the headrest pillars 5a and 5b into the opening portions 7a and 7b of the finisher 73 and fitting the parts 9a and 9b of the spring members 91 and 92 to the notches 5N1 and 5N2 disposed on the headrest pillars 5a and 5b. Thus, the finisher 73 is fixed to the bottom surface 4b of the headrest body 41 (see FIG. 11).

FIG. 11 illustrates a state where the headrest body 41 to which the finisher 73 is mounted is lowered. In this state, the headrest guides 6a and 6b are housed in the recessed portions 731 and 732 of the finisher 73. Accordingly, there is no gap between the finisher 73 and the top surface of the seat back 3. That is, similarly to the shape illustrated in FIG. 9B, the headrest body 41 and the seat back 3 become the integral shape when viewed from the rear. This ensures improving the quality of integral external appearance of the headrest body 41 with the seat back 3.

The second embodiment can obtain the effects similar to those of the first embodiment.

### Other Modifications

The following describes some modifications.

(1) As illustrated in FIG. 5A and FIG. 5B, while the first embodiment uses the one spring member 9, the configuration is not limited to this. As described in the second embodiment, the configurations of the pair of fixing portions 11a1 and the spring member 91, and the pair of fixing portions 11b1 and the spring member 92 may be employed to the finisher 7 or 71 of the first embodiment.

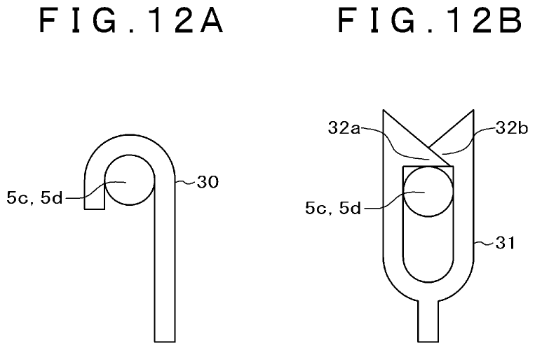

(2) With the first embodiment and the second embodiment, while the finisher 7, 71, or 73 is fixed to the bottom surface of the headrest body 41 using the notches 5N1 and 5N2 disposed on the headrest pillars 5a and 5b and the spring member 9, 91, 92 (9a and 9b), the configuration is not limited to this. The finisher 7, 71, or 73 may be mounted to the bottom surface of the headrest body 41 with the configuration illustrated in FIG. 12A and FIG. 12B. FIG. 12A is a drawing illustrating a modification of a configuration of mounting the finisher to the bottom surface of the headrest body and is a drawing illustrating a J-shaped hook. FIG. 12B is a drawing illustrating a modification of the configuration of mounting the finisher to the bottom surface of the headrest body and is a drawing illustrating a clamp.

As illustrated in FIG. 12A, a pair of J-shaped hooks 30 may be disposed on the back surface of the finisher 7, 71, or 73. The pair of J-shaped hooks 30 are hooked to the horizontal portions 5c and 5d of the headrest frame 8 illustrated in FIG. 4 to ensure fixing the finisher 7, 71, or 73 to the bottom surface of the headrest body 41.

As illustrated in FIG. 12B, a pair of clamps 31 may be disposed on the back surface of the finisher 7, 71, or 73. The pair of clamps 31 is configured to each have lock claws 32a and 32b disposed so as to be opposed to one another. The lock claws 32a and 32b of each of the pair of clamps 31 are hooked to the horizontal portions 5c and 5d of the headrest frame 8 illustrated in FIG. 4, thus ensuring fixing the finisher 7, 71, or 73 to the bottom surface of the headrest body 41.

While the invention made by the inventor has been specifically described based on the embodiments, this invention is not limited to the above-described embodiments, and obviously, variously changeable.

What is claimed is:

1. A headrest comprising:
a headrest body;
a headrest pillar that projects from a bottom surface of the headrest body; and
a finisher that has an opening portion into which the headrest pillar is inserted,
wherein the headrest pillar extends to an inside of the headrest body, and
the finisher is fixed to the headrest pillar at the inside of the headrest body, the finisher covering the bottom surface of the headrest body.

2. The headrest according to claim 1,
wherein the headrest pillar has a notch,
the finisher includes a spring member on a back surface thereof, the spring member being disposed so as to go across the opening portion, and
the spring member is fitted to the notch to fix the finisher to the headrest pillar.

3. The headrest according to claim 2,
wherein the finisher has a recessed portion configured to house a headrest guide disposed at a seat back,
the recessed portion has a surface opposed to the headrest body, and
the surface of the recessed portion includes the opening portion and the spring member.

4. A vehicle seat comprising:
a seat cushion;
a seat back; and
a headrest,
wherein the headrest includes:
a headrest body;
a headrest pillar that projects from a bottom surface of the headrest body, the headrest pillar being fixed to the seat back; and
a finisher that has an opening portion into which the headrest pillar is inserted,
the headrest pillar extends to an inside of the headrest body, and
the finisher is fixed to the headrest pillar at the inside of the headrest body, the finisher covering the bottom surface of the headrest body.

5. The vehicle seat according to claim 4,
wherein the headrest pillar has a notch,
the finisher includes a spring member on a back surface thereof, the spring member being disposed so as to go across the opening portion, and
the spring member is fitted to the notch to fix the finisher to the headrest pillar.

6. The vehicle seat according to claim 5,
wherein the seat back includes a headrest guide that fixes the headrest pillar,
the finisher has a recessed portion configured to house the headrest guide,
the recessed portion has a surface opposed to the headrest body, and
the surface of the recessed portion includes the opening portion and the spring member.
